(19) United States
(12) Patent Application Publication
(10) Pub. No.: US 2010/0247842 A1
(43) Pub. Date: Sep. 30, 2010

(54) Leather decorative plate and its manufacturing method

(76) Inventor: Hung Ming Chen, Taipei (TW)

Correspondence Address: Muncy, Geissler, Olds & Lowe, PLLC, 4000 Legato Road, Suite 310, FAIRFAX, VA, 22033, US

(21) Appl. No.: 12/010,102

(22) Filed: Jan. 18, 2008

(51) Int. Cl. B32B 9/02; B32B 9/04; B32B 27/40; B29C 53/36; B29C 51/00

(52) U.S. Cl. 428/91; 428/174; 264/266; 156/245; 264/265

(57) ABSTRACT

A leather decorative plate comprises a leather layer that is provided with a thermoplastic PU layer on its inner surface. The thermoplastic PU layer is bent to form a space. A method for manufacturing the leather decorative plate comprises the steps of attaching a thermoplastic PU layer to the inner surface of a leather layer, placing the two layers into a mold for proceeding with heating and pressing procedures and softening the thermoplastic PU layer to shape simultaneously the leather layer and the thermoplastic PU layer, forming a space defined by the inner surface of the thermoplastic PU layer for covering directly the surface of a 3C product. In practice, the thermoplastic layer and the leather layer can be heated in advance and then are put into the mold to be pressed to form a faceplate.

### BACKGROUND OF THE INVENTION

1. Field of the Invention

The present invention relates to a leather decorative plate and its manufacturing method and, more particularly, to a leather decorative plate, wherein leather and thermoplastic polyurethane (PU) layers combined and molded by heating and pressing procedures are for covering the surface of all products which are belonged computer, communication, and consumer electronics (3C products).

2. Description of the Prior Art

The faceplates of 3C products in the market are usually manufactured by spraying or sputtering a protective layer on the surface of a case made of plastics, aluminum alloy, or acrylic material. By the method mentioned above, only faceplates of different colors can be manufactured and it fails to produce faceplates made of different wood grains, fabric grains, or leather grains. Thereby, the faceplates produced by the above method have no three-dimensional visual effect.

In order to solve the problem mentioned above, some manufacturers attach fabric, metal, leather, or woody material to a case surface for forming unique three-dimensional grains on the surface of a faceplate. For example, leather can be covered around the surface of a case for producing beautiful leather grains and desired tactile sense. However, covering the leather around the surface of the case needs to proceed with several steps to fix the leather on the surface of the case because of the soft properties of leather, such as fur-skins or artificial leather. Consequently, the cost to production is increased. Besides, the leather and the case can be adhered with each other, but the adhering force for connecting the leather and the case is not solid because the leather and the case are made of different types of material. Thereby, the leather may detach easily from the case because of gradually weakened adhering force or the inherent tension of the leather after a long period time of use.

Accordingly, the applicant tried to coat resin on the inner surface of a piece of leather to make the resin infiltrate deeply into the leather from its inner surface. After the resin is hardened, it will be integrated into the leather to form a leather faceplate. Thereby, steps for manufacturing a faceplate can be simplified and the manufacturing cost can be lowered. However, the quality of the products is not stable because of some problems that may occur during the process of coating resin, such as the problem of uneven coating thickness and the overflow of the resin.

Moreover, some manufacturers produce faceplates by means of injection molding method. This method includes steps of: coating a thin polycarbonate (PC) membrane on the inner surface of a piece of leather, placing the piece of leather into a mold after processing its surface, injecting liquid PC onto the PC membrane via a pressure of several hundred kilograms per square centimeter to form the leather. However, the original three-dimensional effect produced by using the leather is lost because the uneven grains on the outer surface of the piece of leather are flattened during the injection molding process under high pressure. Besides, the thin PC membrane will become solid after the PC membrane is hardened. Thereby, it may be difficult to manufacture faceplates if their curve is too small or they have deeper recesses and the yield rate will be low.

In order to solve the problems mentioned above to simplify the procedures of manufacturing a leather decorative plate, also to ensure the quality of the produced leather decorative plate, and to increase the yield rate and reduce the manufacturing cost, inventor had the motive to study and develop the present invention after hard research.

### SUMMARY OF THE INVENTION

The main object of the present invention is to provide a leather decorative plate and its manufacturing method, where the leather decorative plate is formed by covering a leather layer to a thermoplastic polyurethane (PU) layer and the combination of the leather and thermoplastic PU layers is proceeded with the heating and pressing procedures. By attaching the leather decorative plate to the surface of a 3C product, the sale of the 3C product will be promoted by the stimulation from the three-dimensional grains on the leather surface and consumers will be sure to be attracted. Besides, the manufacturing procedures of a leather decorative plate can be simplified and the manufacturing cost can be reduced accordingly.

In order to achieve the above object, the present invention provides leather decorative plate comprising a leather layer and a thermoplastic PU layer. The leather layer includes an inner surface and an outer surface. The thermoplastic PU layer is attached to the inner surface of the leather layer and a space where the 3C product will be covered is formed by bending the thermoplastic PU layer. Thereby, the leather decorative plate can be attached directly to the surface of a 3C product.

In practice, the present invention further includes an adhesive layer and a connecting layer for combining the leather layer and the thermoplastic PU layer together.

The method for manufacturing a leather decorative plate comprises steps of: a. providing a leather layer; b. attaching a thermoplastic PU layer to the inner surface of the leather layer; and c. placing the thermoplastic PU and the leather layers into a mold, softening the thermoplastic PU layer by heating, and bending the inner surface of the thermoplastic PU layer to form a space by pressing simultaneously the leather and the thermoplastic PU layers.

In practice, the mold includes an upper die and a lower die, where the lower die has a shape corresponding to the space for forming the combination of the leather and the thermoplastic PU layers.

In practice, the step b is that the thermoplastic PU layer is adhered to the leather layer via an adhesive layer.

In practice, the present invention further includes a step: providing a connecting layer between the inner surface of the leather layer and the thermoplastic PU layer.

In practice, the leather layer and the thermoplastic PU layer can be pre-heated and then placed into a mold to form a faceplate.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is a perspective view of a first embodiment of a leather decorative plate of the present invention.

FIG. 2 is a sectional view of FIG. 1 along A-A′ line.

FIG. 3 is a using-state diagram of the first embodiment of the leather decorative plate of the present invention.

FIG. 4 is a sectional view of a second embodiment of a leather decorative plate of the present invention.

FIG. 5 is a flow chart of a first embodiment of a method for manufacturing a leather decorative plate of the present invention.

FIG. 6 is a sectional view for showing a leather decorative plate of the present invention in a mold.

FIG. 7 is a flow chart of a second embodiment of a method for manufacturing a leather decorative plate of the present invention.

### DETAILED DESCRIPTION OF THE PREFERRED EMBODIMENTS

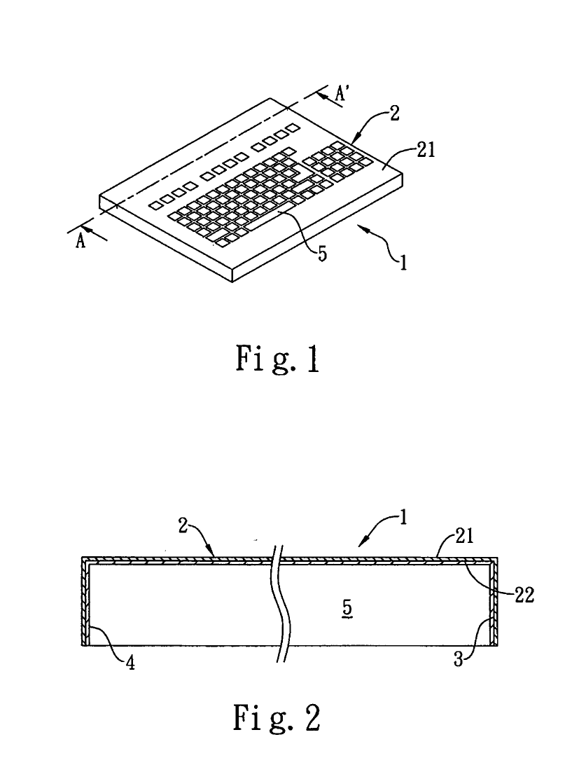

Please refer to FIGS. 1 and 2 showing a first embodiment of a leather decorative plate 1 of the present invention. The leather decorative plate 1 comprises a leather layer 2, an adhesive layer 3, and a thermoplastic polyurethane (PU) layer 4.

The leather layer 2 is a rectangular case and can be made of fur-skins or artificial leather. The leather layer 2 includes an outer surface 21 and an inner surface 22 that corresponds to the outer surface 21.

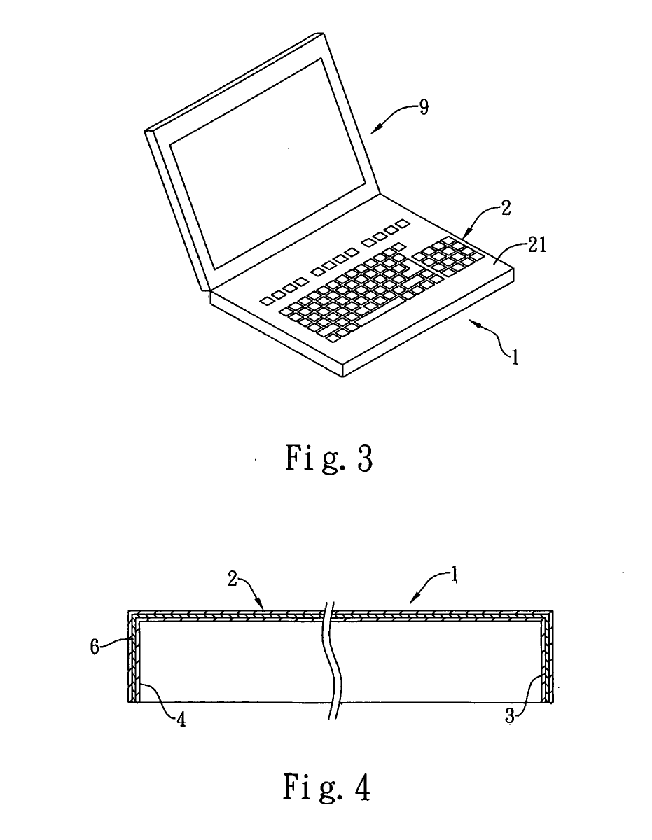

The thermoplastic PU layer 4 is attached to the inner surface of the leather layer 2 via the adhesive layer 3 that is formed by coating adhesives. After being attached to the inner surface of the leather layer 2, the inner surface of the thermoplastic PU layer 4 is bent to form a space 5 for covering the surface of a notebook computer 9 (as shown in FIG. 3). In practice, the thermoplastic PU layer 4 can be replaced with polyvinyl chloride (PVC), polypropylene (PP), acrylonitrile butadiene styrene (ABS), polyethylene (PE), polyethylene terephthalate (PET), or other similar material.

Please refer to FIG. 4 which shows a second embodiment of a leather decorative plate 1 of the present invention. A connecting layer 6 is provided between the inner surface of the leather layer 2 and the thermoplastic PU layer 4. The connecting layer 6 is made of thin membrane of thermoplastic PU material and is served as a transitional interface when the leather layer 2 and the thermoplastic PU layer 4 are attached with each other, so that the leather layer 2 and the thermoplastic PU layer 4 can be combined firmly. The leather layer 2 and the thermoplastic PU layer 4 can be in any different designs that are suitable for attaching to the surfaces of different computer, communication, and consumer electronics (3C) products.

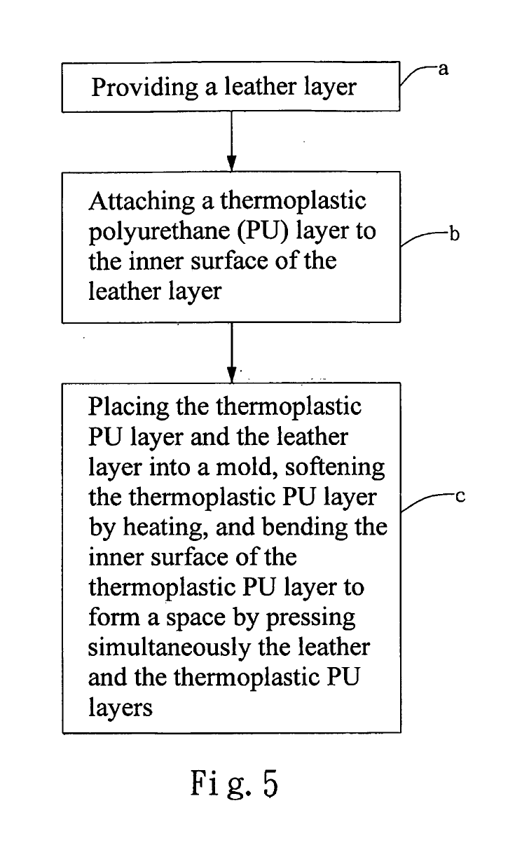

Please refer to FIG. 5 which shows a first embodiment of a method for manufacturing a leather decorative plate of the present invention. The method comprises following steps:

a. providing a leather layer;

b. attaching a thermoplastic polyurethane (PU) layer to the inner surface of the leather layer; and

c. placing the thermoplastic PU layer and the leather layer into a mold, softening the thermoplastic PU layer by heating, and bending the inner surface of the thermoplastic PU layer to form a space by pressing simultaneously the leather and the thermoplastic PU layers.

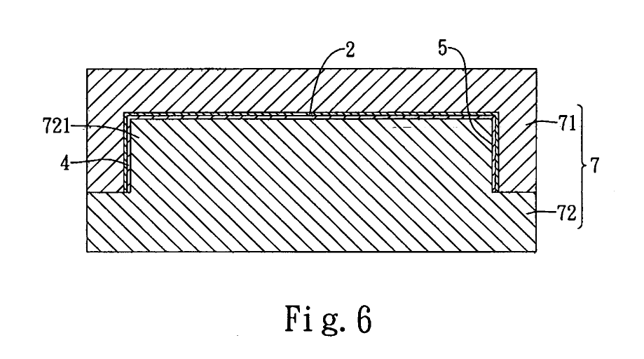

Besides, another step is further provided after the step a. That step is to provide a connecting layer 6 between the inner surface of the leather layer 2 and the thermoplastic PU layer 4. In the step b, the thermoplastic PU layer 4 and the leather layer 2 are adhered with each other via an adhesive layer 3. As shown in FIG. 6, the mold 7 includes an upper die 71 and a lower die 72. The lower die 72 has a protrusion part 721 corresponding to the space 5 for forming the combination of the leather layer 2 and thermoplastic PU layer 4. In practice, the protrusion part 721 can be provided under the upper die 71 for forming the space 5 of the thermoplastic PU layer 4.

When the thermoplastic PU layer 4 is placed on the protrusion part 721 of the lower die 72, the thermoplastic PU layer 4 can be softened to be plastic by a procedure of heating the lower die 72. Besides, the thermoplastic PU layer 4 can also be softened by heating the upper die 71 instead of heating the lower die 72 or by heating both of the upper die 71 and the lower die 72. If about 20 kilograms per square centimeter is exerted on the combination of the upper and lower dies 71, 72, the thermoplastic PU layer 4 and the leather layer 2 will be deformed simultaneously. When the temperature is decreased, the thermoplastic PU layer 4 and the leather layer 2 are cooled and formed to form a rectangular case suitable for covering the notebook computer 9. In practice, the leather layer 2 can be formed in a curve shape and served as a decorative plate for the case of a mouse. Besides, the leather layer 2 also can be formed in any other shapes corresponds to the shapes of personal digital assistants, MP3 players, or other 3C products for being adhered to the surface of a 3C products.

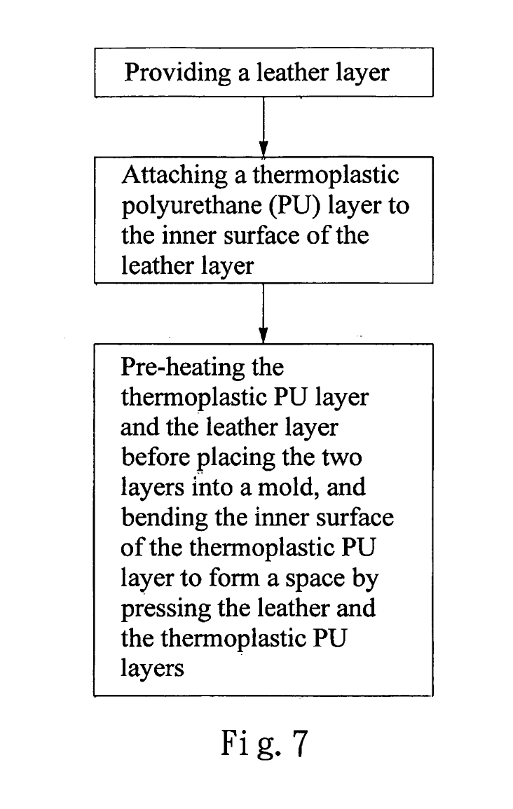

Please refer to FIG. 7 which shows a second embodiment of a method for manufacturing a leather decorative plate of the present invention. In this method, the thermoplastic PU layer and the leather layer are heated in advance and then are placed into a mold to form a faceplate.

Therefore, the present invention has the following advantages:
1. The leather layer and the thermoplastic PU layer are combined before proceeding with heating and pressing procedures, so that the processing procedures can be simplified and the manufacturing cost can be reduced.
2. The thickness of the leather of the present invention can be kept constant by using the thermoplastic PU layer, so that the leather decorative plate of the present invention can be adhered to the surface of a 3C product while its quality can be ensured.
3. The three-dimensional grains on the leather can be kept effectively by forming the leather and thermoplastic PU layers under low pressure, so that the sale of the products that are covered by the leather decorative plate of the present invention can be promoted.

Accordingly, as disclosed in the above description and attached drawings, the present invention can provide a leather decorative plate and its manufacturing method, by using which, the procedures of manufacturing a leather decorative plate can be simplified, the quality of the produced leather decorative plate can be ensured, the yield rate can be increased, and manufacturing cost can be reduced. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A leather decorative plate, comprising:
a leather layer including an inner surface and an outer surface; and
a thermoplastic polyurethane (PU) layer that is attached to the inner surface of the leather layer and the inner surface of the thermoplastic PU layer is bent to form a space for covering the surface of a 3C product.

2. The leather decorative plate as claimed in claim 1, wherein the leather layer is made of fur-skins or artificial leather.

3. The leather decorative plate as claimed in claim 2 further including an adhesive layer that is provided between the inner surface of the leather layer and the thermoplastic PU layer.

4. The leather decorative plate as claimed in claim 2 further including a connecting layer that is provided between the inner surface of the leather layer and the thermoplastic PU layer.

5. The leather decorative plate as claimed in claim 1 further including an adhesive layer that is provided between the inner surface of the leather layer and the thermoplastic PU layer.

6. The leather decorative plate as claimed in claim 1 further including a connecting layer that is provided between the inner surface of the leather layer and the thermoplastic PU layer.

7. A method for manufacturing a leather decorative plate, comprising steps of:
a. providing a leather layer;
b. attaching a thermoplastic polyurethane (PU) layer to the inner surface of the leather layer; and
c. placing the thermoplastic PU layer and the leather layer into a mold, softening the thermoplastic PU layer by heating, and bending the inner surface of the thermoplastic PU layer to form a space by pressing simultaneously the leather and the thermoplastic PU layers.

8. The method for manufacturing a leather decorative plate as claimed in claim 7, wherein the mold includes an upper die and a lower die and the lower die has a shape corresponding to the space for forming the combination of the leather and the thermoplastic PU layers.

9. The method for manufacturing a leather decorative plate as claimed in claim 7, wherein the step b is that the thermoplastic PU layer is adhered to the leather layer via an adhesive layer.

10. The method for manufacturing a leather decorative plate as claimed in claim 9 further including a step: providing a connecting layer between the inner surface of the leather layer and the thermoplastic PU layer.

11. A method for manufacturing a leather decorative plate, comprising steps of:
a. providing a leather layer;
b. attaching a thermoplastic polyurethane (PU) layer to the inner surface of the leather layer; and
c. pre-heating the thermoplastic PU layer and the leather layer before placing the two layers into a mold, and bending the inner surface of the thermoplastic PU layer to form a space by pressing the leather and the thermoplastic PU layers.
